(19) United States
(12) Patent Application Publication
(10) Pub. No.: US 2009/0243507 A1
(43) Pub. Date: Oct. 1, 2009

(54) SUNNY-CLOUDY SCALE FOR SETTING COLOR TEMPERATURE OF WHITE LIGHTS

(76) Inventors: Andres Antonio Lucero-Vera, Eindhoven (NL); Elmo M.A. Diederiks, Eindhoven (NL); Tatiana Lashina, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 12/092,292

(22) PCT Filed: May 26, 2006
(86) PCT No.: PCT/IB2006/051684

§ 371 Date: May 1, 2008

Related U.S. Application Data
(60) Provisional application No. 60/686,501, filed on Jun. 1, 2005.

(51) Int. Cl. H05B 37/02

(52) U.S. Cl. 315/291

(57) ABSTRACT

A control (410) for adjusting (420) the color output of a white light (430) provides an interface (210, 220, 301) that does not refer to, or depend upon an understanding of, color-temperature. The user interface control (210, 220, 301) uses the analogy (260, 270) of the light produced on cloudy days and the light produced on sunny days to distinguish between a low color-temperature output and a high color-temperature output. Using this cloudy-sunny description (260, 270) of the range of control (155, 255) of the light output, the terms “color” or “color-temperature” need not be introduced in the description of the output of a “white” light source (430).

This invention relates to the field of lighting control systems, and in particular to a user-interface control that facilitates the setting of color temperature in a light device that provides variable color temperature settings.

The light output from a light source has a number of aspects that characterize the light. Incandescent lights, fluorescent lights, halogen lights, and so on, each exhibit different visual characteristics, even if these lights are nominally the same color (white), have the same output intensity (lumens), and so on.

In an attempt to identify how different light outputs are perceived, and therefore identify distinguishing characteristics for selecting light sources to provide a desired output, a variety of standard measures have been defined. One such measure is the “color-temperature” of a light source. As the temperature of a light source, such as a tungsten filament, increases, the characteristics of the light energy produced changes, for example, from a “red-hot” light when the filament begins to emit photons, through “white-hot” light, and on to “blue-hot” light.

The CIE has defined a color temperature standard that defines the “color” of white light, based on the color produced by a theoretical black body radiator when heated to the corresponding color temperature; this temperature is specified in degrees Kelvin. For example, a light source, such as an incandescent bulb, that is rated at 2700° K is a light source that produces white light that is of the same color as that of the theoretical black body radiator when it is heated to 2700° K. Another light source, such as a fluorescent bulb, that is rated at 4100° K is a light source that produces white light that is of the same color as the same theoretical black body radiator when it is heated to 4100° K. In like manner, flash bulbs or metal halide light bulbs may be rated at 5000° K or more. Note that this color temperature scale is only one measure of the light source; other measures, such as the common measure of the luminance, or brightness of the light source, or the less common measure of Color Rendering Index (CRI), are used to describe and distinguish among available light sources.

Until recently, if a user desired a light source for a particular environment, or to achieve a particular ambiance, the user selected the source based on the desired output characteristics. For example, to achieve a “warm and cozy” ambiance, such as in a hotel or restaurant, a user would select an incandescent light source; to achieve a “neat and clean” ambiance, such as in an office or classroom, a user would select a fluorescent light source; to achieve an “exacting” ambiance, such as in a jewelry store or medical examination room, a user would select a metal halide light source. After installing the selected light source, the user's control option was limited to a control of the output luminance.

Koninklijke Philips Electronics, N.V., and other lighting manufacturers, have developed technologies that allow the color temperature of a white light source to be controlled. With these technologies, the same light source may be adjustable to provide the ‘warm’ output of an incandescent, the ‘cool’ output of a fluorescent, and the ‘exacting’ output of a metal halide. U.S. Pat. No. 5,861,717, “LIGHTING SYSTEM FOR CONTROLLING THE COLOR TEMPERATURE OF ARTIFICIAL LIGHT UNDER THE INFLUENCE OF THE DAYLIGHT LEVEL”, issued 19 Jan. 1999 to Begemann et al., and U.S. Pat. No. 6,234,645, “LED LIGHTING SYSTEM FOR PRODUCING WHITE LIGHT”, issued 22 May 2001 to Borner et al., describe white light sources with controllable color temperature, and are incorporated by reference herein. As these technologies are incorporated into mass-produced lighting systems, users will have the ability to control both the brightness or luminance of the light, as well as the ‘color’ of the output ‘white’ light.

FIG. 1 illustrates an example user input device 110 for the control of the color output of the white light, from ‘cool’ at 2500° K to ‘exacting’ at 5000° K. This control will be in addition to the conventional control that may also be provided for controlling the luminance of the output. As illustrated in FIG. 1, a control knob 150 is adjustable 155 from a lower bound 160 to an upper bound 170 of color-temperature. The particular bounds 160, 170 will be dependent upon the range of color-temperature control provided by the light source being controlled by this input device 110.

As is evident from FIG. 1, the user control 110 assumes that the intended user understands the correspondence between color-temperature and the color of the white light that will be produced at a given setting. The intended user of the control 110 will be expected to understand that a low setting, such as 2700° K corresponds to a “warm” ambiance, while a higher color temperature setting, such as 4000° K corresponds to a “cool” ambiance. Eventually, as the concept of adjustable color temperature becomes commonplace with continued use of the control 110, the user will be able to set the temperature to achieve a desired color output without conscious thought, but the initial user-acceptance and/or marketability of the control 110 will be affected by this learning-period.

In like manner, the user-interest, and hence the marketability, of a light source that provides for adjustable color-temperature, beyond the specialized users who understand color-temperature, will be dependent upon the ability of the vendors of such light sources to teach the “mass-market user” the meaning of “color-temperature”, beyond the technical definition of “providing the same color as that produced by a theoretical black body radiator when heated to that temperature”. A particularly difficult aspect of this mass-market education will be the use of the term “color-temperature” while attempting to sell a “white” light.

It is an object of this invention to provide a user control for adjusting the color output of a white light source that is more intuitive and natural than one that is based on adjusting the color temperature, per se. It is a further object of this invention to provide a light source with a user control for adjusting the color-temperature of the light source that does not require a user to understand the concept of color-temperature.

These objects, and others, are achieved by a user interface for adjusting the color output of a white light that does not refer to, or depend upon an understanding of, color-temperature. The user interface control uses the analogy of the light produced on cloudy days and the light produced on sunny days to distinguish between a low color-temperature output and a high color-temperature output. Using this cloudy-sunny description of the range of control of the light output, the terms “color” or “color-temperature” need not be introduced in the description of the output of a “white” light source.

The invention is explained in further detail, and by way of example, with reference to the accompanying drawings wherein:

FIG. 1 illustrates an example color-temperature based user-interface control device.

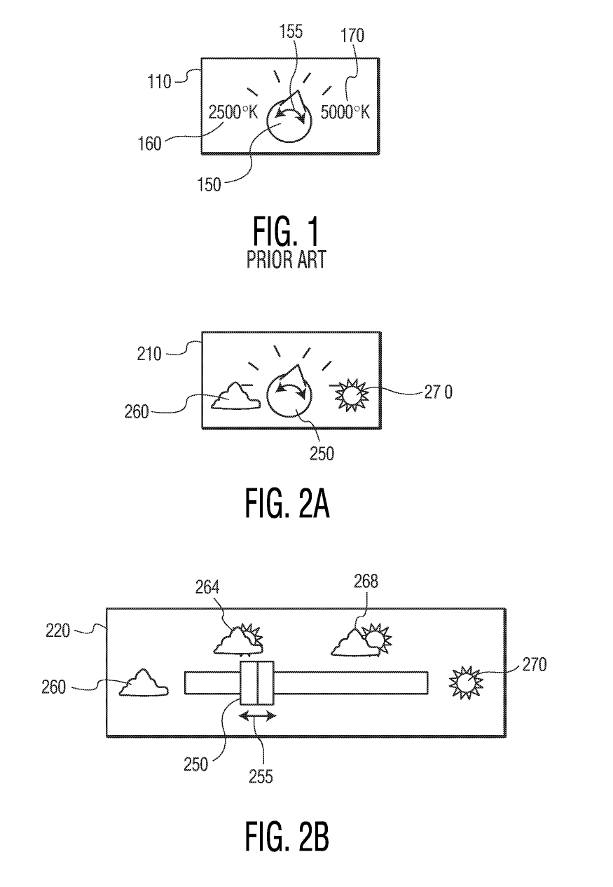

FIGS. 2A and 2B illustrate example sunny-cloudy based user-interface control devices in accordance with this invention.

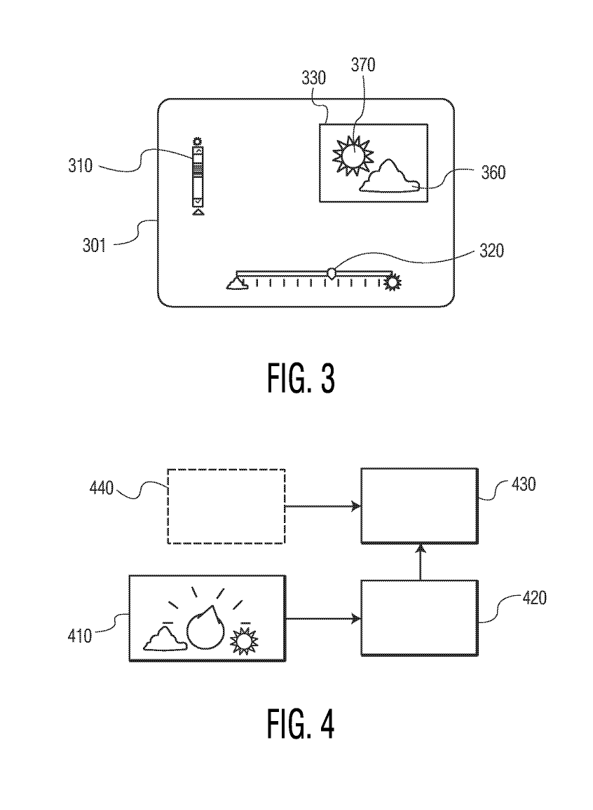

FIG. 3 illustrates other example sunny-cloudy based user-interfaces suitable for use on a display screen in accordance with this invention.

FIG. 4 illustrates an example block diagram of a light system in accordance with this invention.

Throughout the drawings, the same reference numeral refers to the same element, or an element that performs substantially the same function. The drawings are included for illustrative purposes and are not intended to limit the scope of the invention.

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. For purposes of simplicity and clarity, detailed descriptions of well-known devices, circuits, and methods are omitted so as not to obscure the description of the present invention with unnecessary detail.

This invention is premised on the observation that although the color output of a white light is defined by color-temperature, most people are unfamiliar with the term color output as applied to nominally white light, and are even less familiar with the term color-temperature being used to distinguish the “warm” glow of an incandescent bulb from the “cold” light from a fluorescent bulb, particularly when the color-temperature of the “warm” glow is substantially lower than the color-temperature of the “cold” light. The inventors recognized that different color output from the same white light source is regularly experienced by people in the effects that clouds have on the light received from the sun. By using this cloudy-light/sunny-light analogy to low-color-temperature/high-color-temperature, the concept, and appeal, of being able to adjust a light source from a cloudy effect to a sunny effect will be more easily conveyed, compared to being able to adjust a light source from low-color-temperature to high-color-temperature.

FIG. 2A illustrates an example lighting control 210 in accordance with this invention. The lighting control 210 includes a user controllable element/knob 150, that is configured to provide a signal to a light source (not shown), corresponding to a rotational position of the knob 150. The signal is provided via a user interface device (not shown), such as a rheostat, or any of a variety of other devices commonly known in the art, that transform a rotational position to an electronic signal. In accordance with this invention, the labeling on the control 210 includes two indicators 260, 270 identifying the minimum and maximum extent of rotation of the knob 150, and these indicators include an image of a cloud 260 and an image of a sun 270. By providing these cloud and sun indicators, the user is immediately presented with a symbolism that intuitively conveys the lighting effect that a rotation of the knob 150 will produce. These sun and cloud indicators can be in a variety of forms, such as symbols that include sun and cloud icons, images or drawings of a cloudy or sunny sky or scene, text that reads “cloudy” or “sunny”, and so on.

FIG. 2B illustrates another example lighting control 220 in accordance with this invention. In this embodiment, the user controllable element 250 is a slide-bar, that can be moved in a lateral direction 255 to a desired position. As in the example control 210, the range of control is labeled by a cloud indicator 260 and a sun indicator 270. Optionally, intermediate points between these extremes may be labeled with, for example, a “mostly-cloudy” indicator 264, or a “partly cloudy” indicator 268. As with the control 210, by providing these cloud and sun indicators, and the optional intermediate indicators, the user is immediately presented with a symbolism that intuitively conveys the lighting effect that a positioning of the slide-bar 250 will produce.

The principles of this invention are not limited to the examples of FIGS. 2A and 2B, and may also be extended to non-mechanical controllers as well. FIG. 3 illustrates example embodiments of this invention on a display device, such as a computer screen, a display on a remote control device, and so on. The example embodiments 310, 320, 330 are illustrated on a single display screen 301, for convenience; typically, only one of the embodiments would need to be provided on a screen 301. In each of these embodiments, the position of the user-controllable element is converted by interface software (not illustrated) into a signal corresponding to the position of the user-controlled element that is communicated to a light source (not illustrated) to effect a control of the color-temperature of the light source.

The embodiment 310 illustrates a conventional computer slide-bar, except that, in accordance with this invention, the extremes of the slide-bar include cloud and sun symbols. The embodiment 320 illustrates an alternative computer slide-bar, again with cloud and sun symbols in accordance with this invention.

The embodiment 330 illustrates an interactive display window wherein a user manipulates the positions of the cloud 360 and sun 370 symbols to achieve a desired effect. For example, moving the sun 370 to the center of the window, and the cloud 360 to an edge of the window will produce a predominantly “sunny” effect. Moving the cloud 360 to cover the sun 370 will produce a predominantly “cloudy” effect.

The embodiment 330, being less constrained than a one-dimensional control, such as a rotating knob or lateral slide-bar provides additional advantages as well. In a preferred embodiment, the position of the symbols 360, 370 control other aspects of the light source. For example, if the sun symbol 370 is moved to the edge of the window, such that only some of the symbol 370 is visible, the brightness of the light source may be dimmed. In like manner, the height of the cloud symbol 360 may be used to vary one or more aspects of the light source, corresponding to the difference perceived when a low-cloud cover is present versus when a high-cloud cover is present. Similarly, the height of the sun symbol 370 may be used to create lighting effects corresponding to “sun-rise”, “high-noon”, “sun-set” conditions.

This multiple-aspect control is not limited to the embodiment 330. Copending U.S. provisional patent application 60/629,798, “MULTI-DIMENSIONAL CONTROL OF LIGHTING PARAMETERS”, filed 19 Nov. 2004 for Elmo M. A. Diederiks et al., Attorney Docket US040492, and incorporated by reference herein, for example, teaches controlling multiple aspects of a light via a multi-dimensional controller, such as a joystick. In accordance with this invention, symbols corresponding to cloudy-sunny conditions are placed on the multi-dimensional controller, indicating a direction of control that provides a color-temperature control of the light source.

FIG. 4 illustrates an example block diagram for a lighting system in accordance with this invention. As illustrated, the lighting system includes a light device 430 that is controlled by a color-temperature controller 420, as well as optional other controllers 440, such as a brightness controller. In accordance with this invention, a user-interface device 410 that includes cloud and sun symbols determines a user input and provides a corresponding signal to the color-temperature controller 420 to effect a corresponding setting of the color-temperature of the light device 430. Optionally, as discussed above, the interface device 410 may also provide signals (not illustrated) to the other controllers 440.

The foregoing merely illustrates the principles of the invention. It will thus be appreciated that those skilled in the art will be able to devise various arrangements which, although not explicitly described or shown herein, embody the principles of the invention and are thus within its spirit and scope. For example, although the symbols used in the example embodiments are symbols of a cloud and a sun, one of ordinary skill in the art will recognize that other meteorological symbols may be used. The cloud and sun symbols are selected as being most recognizable to potential users of the system, but in different situations, or in different cultures, other symbols may be more applicable. Similarly, the nature of the range of color-temperature control provided by a particular light source may suggest the use of alternative symbols.

These and other system configuration and optimization features will be evident to one of ordinary skill in the art in view of this disclosure, and are included within the scope of the following claims.

In interpreting these claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) each of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise;

h) no specific sequence of acts is intended to be required unless specifically indicated; and

i) the term “plurality of” an element includes two or more of the claimed element, and does not imply any particular range of number of elements; that is, a plurality of elements can be as few as two elements.

1. A lighting control (410) comprising:
a user interface device (210, 220, 301) that provides a signal for controlling a color-temperature (420) of a light source (430) that corresponds to a position (155, 255) of a user-controllable element (150, 250), and
a label corresponding to the user-controllable element (150, 250) that includes at least two indicators (260, 270) corresponding to a minimum and maximum position of the user-controllable element (150, 250),
wherein
the at least two indicators (260, 270) include meteorological symbols.

2. The lighting control of claim 1, wherein
the meteorological symbols include a symbol of a sun (270), and a symbol of a cloud (260).

3. The lighting control of claim 1, wherein
the user interface device (210, 220) includes a rheostat.

4. The lighting control of claim 1, wherein
the user-controllable element (150, 250) includes a knob (150) that rotates (155) from the minimum to the maximum position.

5. The lighting control of claim 1, wherein
the user-controllable element (150, 250) includes a slide-bar (250) that travels laterally (255) from the minimum to the maximum position.

6. The lighting control of claim 1, wherein
the user interface device (210, 220, 301) includes a display screen (301), and
the user-controllable element includes a controllable object (310, 320, 330) on the display screen (301).

7. A lighting control comprising:
a display screen (301),
one or more user-controllable icons (310, 320, 330) on the display screen (301), and
a user-interface that provides a signal for controlling a color-temperature of a light source (430) that is dependent upon a position of the one or more user-controllable icons (310, 320, 330) on the display screen (301),
wherein
the one or more user-controllable icons (310, 320, 330) include meteorological symbols (360, 370).

8. The lighting control of claim 7, wherein
the meteorological symbols (360, 370) include at least one of: a symbol of a cloud (360) and a symbol of a sun (370).

9. A lighting system comprising:
a light (430) that provides illumination in a variety of color temperatures,
a user interface device (410) that provides a control signal to the light that corresponds to a position of a user-controllable element (150, 250, 310, 320, 330), and
a label corresponding to the user-controllable element that includes at least two indicators (260, 270, 360, 370) corresponding to a minimum and maximum position of the user-controllable element,
wherein
the at least two indicators include a symbol of a sun (270, 370), and a symbol of a cloud (260, 360), and
when the user-controlled element is adjusted to correspond with the symbol of the sun (270, 370), the signal is configured to control (420) the light to provide a highest color temperature, and
when the user-controlled element is adjusted to correspond with the symbol of the cloud (260, 360), the signal is configured to control (420) the light to provide a lowest color temperature.

10. The lighting system of claim 9, wherein
the user interface device (410) includes a rheostat.

11. The lighting system of claim 9, wherein
the user-controllable element includes a knob (150) that rotates (155) from the minimum to the maximum position.

12. The lighting system of claim 9, wherein
the user-controllable element includes a slide-bar (250) that travels laterally (255) from the minimum to the maximum position.

13. The lighting system of claim 9, wherein
the user interface device (410) includes a display screen (301), and
the user-controllable element includes a controllable object (310, 320, 330) on the display screen (301).
